(19) United States
(12) Patent Application Publication
(10) Pub. No.: US 2023/0214803 A1
(43) Pub. Date: Jul. 6, 2023

(54) TECHNOLOGIES FOR ELECTRONIC BILL PAY WITH CHECK PRINTING AND PROCESSING

(71) Applicant: AMERICAN LITHO, INC., Carol Stream, IL (US)

(72) Inventors: Donald C. SCHOEN, Carol Stream, IL (US); Howard A. STAPLETON, Carol Stream, IL (US)

(21) Appl. No.: 18/149,457

(22) Filed: Jan. 3, 2023

Related U.S. Application Data
(60) Provisional application No. 63/297,039, filed on Jan. 6, 2022.

(51) Int. Cl. G06Q 20/10; G06Q 20/04

(52) U.S. Cl. CPC G06Q 20/102; G06Q 20/042

(57) ABSTRACT

Technologies for electronic bill pay with check processing include a check print server coupled to a printer and a scanner. The check print server receives multiple bill pay requests, generates multiple pre-print checks based on those requests, and provides the pre-print checks to the printer. The printer prints the checks, and the scanner scans the printed checks and generates check images. The check print server updates a check record for each printed check with a hash of a combined front side image and back side image of the printed check. The check print server receives a check image request that includes a requested hash value and then returns the front side image and the back side image that match the requested hash value. The check print server may receive a check re-print request including a requested hash value. Other embodiments are described and claimed.

### CROSS-REFERENCE TO RELATED APPLICATIONS

This application claims the benefit of and priority to U.S. Patent Application No. 63/297,039, entitled “TECHNOLOGIES FOR ELECTRONIC BILL PAY WITH CHECK PRINTING AND PROCESSING,” which was filed on Jan. 6, 2022, and which is incorporated herein by reference in its entirety.

### BACKGROUND

Typical checking transactions require a paper check issued by a payer to a payee. Certain electronic bill pay systems still require printing and mailing a paper check to certain payees.

### SUMMARY

According to one aspect of the disclosure, a computing device for check processing includes a bill pay interface, a check print manager, a check record manager, and a check image interface. The bill pay interface is to receive a plurality of bill pay requests, wherein each bill pay request is indicative of a payee, an amount, and a unique check identifier. The check print manager is to (i) generate a plurality of pre-print checks as a function of the plurality of bill pay requests and (ii) provide the plurality of pre-print checks to a printer device. The check record manager is to (i) receive a plurality of check images from a scanner device in response to provision of the plurality of pre-print checks to the printer device, wherein the check images are indicative of a plurality of printed checks printed by the printer device, and wherein each check image is indicative of a front side or a back side of a printed check; and (ii) update a check record for each printed check of the plurality of printed checks, wherein each check record is indicative of a unique check identifier, a front side image of the associated printed check, a back side image of the associated printed check, and a hash value of the front side image combined with the back side image. The check image interface is to (i) receive a check image request, wherein the check image request is indicative of a requested hash value, and (ii) return a response record in response to receipt of the check image request, wherein the response record includes the front side image and the back side image that are associated with the requested hash value.

In an embodiment, the printer device is further configured to print the plurality of printed checks in response to the provision of the plurality of pre-print checks to the printer device and the scanner device is configured to scan the plurality of printed checks to generate the plurality of check images. The printer device is configured to scan the plurality of printed checks and scans a front side and a back side of each printed check.

In an embodiment, the bill pay interface is further configured to set a security setting for access; and to receive the plurality of bill pay requests comprises to receive the plurality of bill pay requests in response to successful setting of the security setting. In an embodiment, to receive the plurality of bill pay requests comprises to receive a bill pay request at a REST resource of the check print server; and insert a bill pay request record into a bill pay table in response to receipt of the bill pay request.

In an embodiment, to generate the plurality of pre-print checks comprises to: determine whether a count of the plurality of bill pay requests exceeds a predetermined count threshold; determine whether an elapsed time from a last printing exceeds a predetermined time threshold; and generate the plurality of pre-print checks in response to a determination that the count exceeds the predetermined count threshold or a determination that the elapsed time exceeds the predetermined time threshold.

In an embodiment, to update the check record for each printed check of the plurality of printed checks comprises to read a table of check records from the scanner device, wherein each check record is indicative of a unique check identifier.

In an embodiment, to update the check record for each printed check of the plurality of printed checks comprises, for each printed check of the plurality of printed checks, to: convert the front side image and the back side image of the printed check to a base-64 encoded front side image and a base-64 encoded back side image; determine a first unique check identifier based on a graphical code represented in the front side image or the back side image; find a first check record for the printed check that matches the first unique check identifier; calculate a first hash value of the base-64 encoded front side image combined with the base-64 encoded back side image; and update the first check record with the first hash value, a location of the front side image, and a location of the back side image. In an embodiment, to update the check record for each printed check of the plurality of printed checks further comprises to send an update indicative of the first hash value and the first unique check identifier. In an embodiment, to update the check record for each printed check of the plurality of printed checks further comprises to move the plurality of check images to a data storage location.

In an embodiment, to receive the check image request comprises to validate security of the check image request. In an embodiment, to return the response record comprises to: determine whether a check record includes a hash value that matches the requested hash value of the check image request; and return an error in response to a determination that no check record includes the hash value that matches the requested hash value; wherein to return the response record further comprises to returning the response record in response to a determination that the check record includes the hash value that matches the requested hash. In an embodiment, to return the response record further comprises to: retrieve a front side image and a back side image from a data storage location indicated by the check record in response to the determination that the check record includes the hash value that matches the requested hash; and assign the front side image and the back side image to the response record in response to retrieval of the front side image and the back side image.

In an embodiment, the check image interface is further configured to receive a check re-print request, wherein the check re-print request is indicative of the requested hash value, and retrieve the front side image and the back side image that are associated with the requested hash value. The check print manager is further to prepare a second pre-print check as a function of the front side image and the back side image. In an embodiment, the check print manager is further to provide the second pre-print check to a second printing device, wherein the second printer device comprises a low-volume printer.

According to another aspect, a method for check processing includes receiving, by a check print server, a plurality of bill pay requests, wherein each bill pay request is indicative of a payee, an amount, and a unique check identifier; generating, by the check print server, a plurality of pre-print checks as a function of the plurality of bill pay requests; providing, by the check print server, the plurality of pre-print checks to a printer device; receiving, by the check print server, a plurality of check images from a scanner device in response to providing the plurality of pre-print checks to the printer device, wherein the check images are indicative of a plurality of printed checks printed by the printer device, wherein each check image is indicative of a front side or a back side of a printed check; updating, by the check print server, a check record for each printed check of the plurality of printed checks, wherein each check record is indicative of a unique check identifier, a front side image of the associated printed check, a back side image of the associated printed check, and a hash value of the front side image combined with the back side image; receiving, by the check print server; a check image request, wherein the check image request is indicative of a requested hash value; and returning, by the check print server, a response record in response to receiving the check image request, wherein the response record includes the front side image and the back side image that are associated with the requested hash value.

In an embodiment, the method further includes printing, by the printer device, the plurality of printed checks in response to providing the plurality of pre-print checks to the printer device; and scanning, by the scanner device, the plurality of printed checks to generate the plurality of check images, wherein scanning the plurality of printed checks comprises scanning a front side and a back side of each printed check.

In an embodiment, the method further includes setting, by the check print server, a security setting for access; wherein receiving the plurality of bill pay requests comprises receiving the plurality of bill pay requests in response to successfully setting the security setting. In an embodiment, receiving the plurality of bill pay requests comprises: receiving a bill pay request at a REST resource of the check print server; and inserting a bill pay request record into a bill pay table in response to receiving the bill pay request.

In an embodiment, generating the plurality of pre-print checks comprises determining whether a count of the plurality of bill pay requests exceeds a predetermined count threshold; determining whether an elapsed time from a last printing exceeds a predetermined time threshold; and generating the plurality of pre-print checks in response to determining that the count exceeds the predetermined count threshold or determining that the elapsed time exceeds the predetermined time threshold. In an embodiment, updating the check record for each printed check of the plurality of printed checks comprises reading a table of check records from the scanner device, wherein each check record is indicative of a unique check identifier.

In an embodiment, updating the check record for each printed check of the plurality of printed checks comprises, for each printed check of the plurality of printed checks: converting the front side image and the back side image of the printed check to a base-64 encoded front side image and a base-64 encoded back side image; determining a first unique check identifier based on a graphical code represented in the front side image or the back side image; finding a first check record for the printed check that matches the first unique check identifier; calculating a first hash value of the base-64 encoded front side image combined with the base-64 encoded back side image; and updating the first check record with the first hash value, a location of the front side image, and a location of the back side image. In an embodiment, updating the check record for each printed check of the plurality of printed checks further comprises sending an update indicative of the first hash value and the first unique check identifier. In an embodiment, updating the check record for each printed check of the plurality of printed checks further comprises moving the plurality of check images to a data storage location.

In an embodiment, receiving the check image request comprises validating security of the check image request. In an embodiment, returning the response record comprises determining whether a check record includes a hash value that matches the requested hash value of the check image request; and returning an error in response to determining that no check record includes the hash value that matches the requested hash value; wherein returning the response record further comprises returning the response record in response to determining that the check record includes the hash value that matches the requested hash. In an embodiment, returning the response record further comprises: retrieving a front side image and a back side image from a data storage location indicated by the check record in response to determining that the check record includes the hash value that matches the requested hash; and assigning the front side image and the back side image to the response record in response to retrieving the front side image and the back side image.

In an embodiment, the method further comprises receiving, by the check print server; a check re-print request, wherein the check re-print request is indicative of the requested hash value; retrieving, by the check print server, the front side image and the back side image that are associated with the requested hash value; and preparing, by the check print server, a second pre-print check as a function of the front side image and the back side image. In an embodiment, the method further comprises providing, by the check print server, the second pre-print check to a second printing device, wherein the second printer device comprises a low-volume printer.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for electronic bill pay with check processing;

FIG. 2 is a simplified block diagram of an environment that may be established by a check print server of the system of FIG. 1;

FIG. 3 is a simplified flow diagram of at least one embodiment of a method for electronic bill pay with check processing that may be executed by the check print server of FIGS. 1 and 2;

FIG. 4 is a simplified flow diagram of at least one embodiment of a method for receiving bill pay requests that may be executed by the check print server of FIGS. 1 and 2;

FIG. 5 is a simplified flow diagram of at least one embodiment of a method for generating checks for printing that may be executed by the check print server of FIGS. 1 and 2;

FIG. 6 is a simplified flow diagram of at least one embodiment of a method for processing scanned check images that may be executed by the check print server of FIGS. 1 and 2;

FIG. 7 is a simplified flow diagram of at least one embodiment of a method for processing check image requests that may be executed by the check print server of FIGS. 1 and 2; and

FIG. 8 is a simplified flow diagram of at least one embodiment of a method for processing check re-print requests that may be executed by the check print server of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

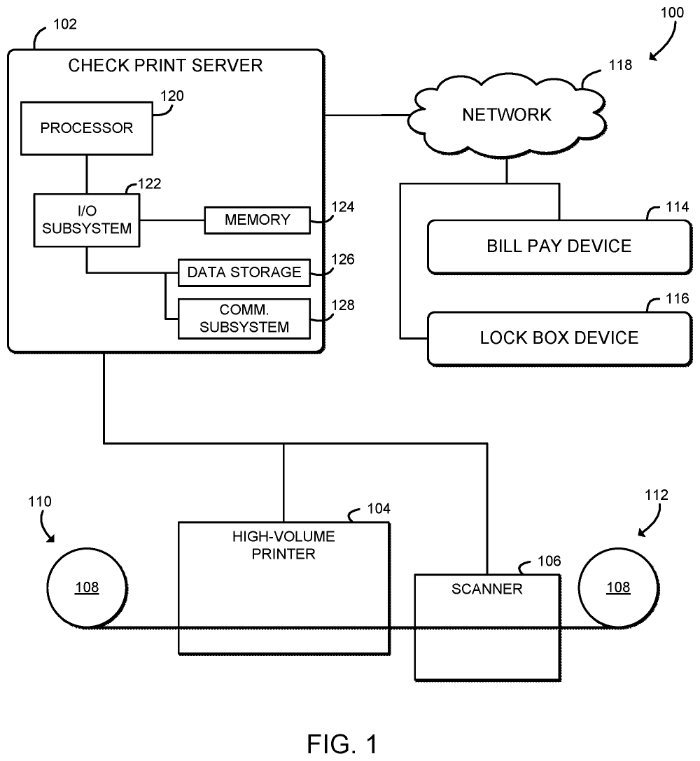

Referring now to FIG. 1, an illustrative system 100 for electronic bill pay with check processing includes a check print server 102, which may be in communication with multiple bill pay devices 114 and lock box devices 116 over a network 118. The check print server 102 is also in communication with a high-volume printer 104 and a scanner 106. In use, as described further below, the check print server 102 receives bill pay requests from the bill pay devices 114 and then generates and prints a batch of checks using the high-volume printer 104. During or immediately after printing, the scanner 106 captures images of the front side and back side of each check. The check print server 102 generates a hash for the combined front side image and back side image for each check. The lock box devices 116 may request check images using this hash value, and the check print server 102 responds with the check images. Thus, the system 100 provides for electronic transmission of check images for corresponding paper checks in circumstances where electronic transactions (e.g., ACH transactions) are not possible with typical systems. Additionally, the system 100 may improve speed and reduce costs compared to existing bill pay systems that, for example, may require printing and mailing paper checks. Further, the system 100 may improve security in electronic bill pay transactions by securing the bill pay request and the check image requests. The system 100 may further improve physical security of electronic bill pay requests, because the printed checks may remain within a secure facility at all times.

The check print server 102 may be embodied as any type of device capable of performing the functions described herein. For example, the check print server 102 may be embodied as, without limitation, a server, a rack-mounted server, a blade server, a workstation, a network appliance, a web appliance, a desktop computer, a laptop computer, a tablet computer, a smartphone, a consumer electronic device, a distributed computing system, a multiprocessor system, and/or any other computing device capable of performing the functions described herein. Additionally, in some embodiments, the check print server 102 may be embodied as a “virtual server” formed from multiple computing devices distributed across the network 118 and operating in a public or private cloud. Accordingly, although the check print server 102 is illustrated in FIG. 1 as embodied as a single computing device, it should be appreciated that the check print server 102 may be embodied as multiple devices cooperating together to facilitate the functionality described below. As shown in FIG. 1, the illustrative check print server 102 includes a processor 120, an I/O subsystem 122, memory 124, a data storage device 126, and a communication subsystem 128. Of course, the check print server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the check print server 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the check print server 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the check print server 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the check print server 102 may be embodied as any communication circuit, device, or collection thereof, capable of enabling communications between the check print server 102, the bill pay device 114, the lock box device 116, and/or other remote devices. The communication subsystem 128 may be configured to use any one or more communication technology (e.g., wireless or wired communications) and associated protocols (e.g., Ethernet, Bluetooth®, Bluetooth Low Energy (BLE), Wi-Fi®, WiMAX, 3G LTE, 5G, etc.) to effect such communication.

As shown in FIG. 1, the check print server 102 is coupled to the high-volume printer 104 and the scanner 106. The high-volume printer 104 may be embodied as a litho web press, a high speed digital ink jet printer, or any other printing system capable of printing checks on two sides (e.g., front and back) at high volumes. For example, in an embodiment the high-volume printer 104 may be capable of printing at least 100,000 checks per hour. The high-volume printer 104 prints checks onto a continuous paper medium 108. As shown in FIG. 1, the paper 108 is stored in rolls 110, 112. Roll 110 is a roll of blank paper that is fed to the high-volume printer 104.

The printed paper 108 output by the printer 104 is continuously fed through the scanner 106, which scans both sides of the paper 108. The scanner 106 may be embodied as any digital scanner, digital camera, or other imaging device capable of capturing images of the paper 108 as it is produced by the printer 104. For example, in the illustrative embodiment, the scanner 106 may be capable of scanning at least 100,000 checks per hour. The scanner 106 may include multiple cameras or other imaging elements to provide redundancy, error correction, or otherwise ensure that all checks printed by the high-volume printer 104 are scanned. As shown in FIG. 1, after being scanned by the scanner 106, the printed checks on the continuous paper 108 are stored on the roll 112.

As shown in FIG. 1, in some embodiments the high-volume printer 104 and the scanner 106 may be coupled directly to the check print server 102. Additionally or alternatively, in some embodiments the check print server 102 may communicate with the high-volume printer 104 and/or the scanner 106 over the network 118, or over a secure network, a virtual private network, an audited network, a data loss protection (DLP) monitored network, or other network connection. The high-volume printer 104 and the scanner 106 may be located in a secure facility. In some embodiments, when printing a roll 112 of printed checks is completed (e.g., when changing to a new roll of blank paper medium 108), the completed roll 112 may be stored in a secure facility such as a bank vault.

Each bill pay device 114 and lock box device 116 may be embodied as any type of computation or computer device capable of performing the functions described herein, including, without limitation, a computer, a workstation, a server, a rack-mounted server, a blade server, a laptop computer, a notebook computer, a tablet computer, a mobile computing device, a wearable computing device, a multiprocessor system, a network appliance, a web appliance, a distributed computing system, a processor-based system, and/or a consumer electronic device. Thus, each of the bill pay device 114 and the lock box device 116 includes components and devices commonly found in a computer or similar computing device, such as a processor, an I/O subsystem, a memory, a data storage device, and/or communication circuitry. Those individual components of the bill pay device 114 and the lock box device 116 may be similar to the corresponding components of the check print server 102, the description of which is applicable to the corresponding components of the bill pay device 114 and the lock box device 116 and is not repeated herein so as not to obscure the present disclosure.

As discussed in more detail below, the check print server 102, the bill pay device 114, and the lock box device 116 may be configured to transmit and receive data with each other and/or other devices of the system 100 over the network 118. The network 118 may be embodied as any number of various wired and/or wireless networks. For example, the network 118 may be embodied as, or otherwise include, a wired or wireless local area network (LAN), a wired or wireless wide area network (WAN), a cellular network, and/or a publicly-accessible, global network such as the Internet. As such, the network 118 may include any number of additional devices, such as additional computers, routers, stations, and switches, to facilitate communications among the devices of the system 100.

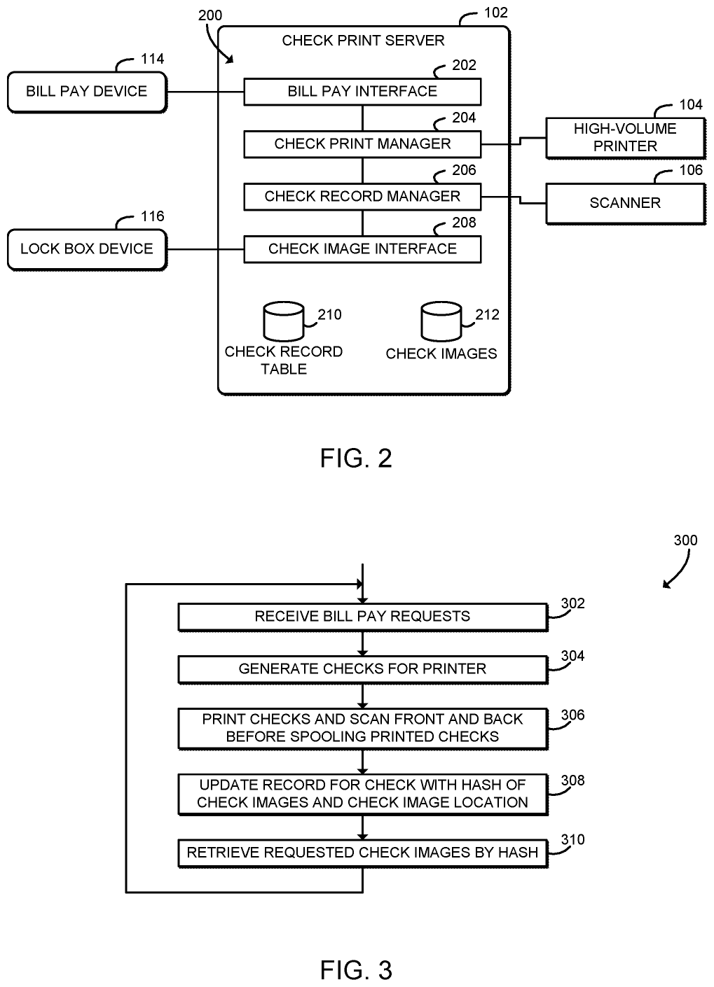

Referring now to FIG. 2, in the illustrative embodiment, the check print server 102 establishes an environment 200 during operation. The illustrative environment 200 includes a bill pay interface 202, a check print manager 204, a check record manager 206, and a check image interface 208. The various components of the environment 200 may be embodied as hardware, firmware, software, or a combination thereof. As such, in some embodiments, one or more of the components of the environment 200 may be embodied as circuitry or a collection of electrical devices (e.g., bill pay interface circuitry 202, check print manager circuitry 204, check record manager circuitry 206, and/or check image interface circuitry 208). It should be appreciated that, in such embodiments, one or more of those components may form a portion of the processor 120, the I/O subsystem 122, and/or other components of the check print server 102.

The bill pay interface 202 is configured to receive a plurality of bill pay requests, for example from one or more of the bill pay devices 114. Each bill pay request is indicative of payment information such as a payee, an amount, and a unique check identifier. The bill pay interface 202 may be further configured to set a security setting for access, and to receive the bill pay requests after successfully setting of the security setting. Receiving the plurality of bill pay requests may include receiving a bill pay request at a REST resource of the check print server 102 and inserting a bill pay request record into a bill pay table in response to receiving the bill pay request.

The check print manager 204 is configured to generate a plurality of pre-print checks as a function of the plurality of bill pay requests. Generating the plurality of pre-print checks may include determining whether a count of the plurality of bill pay requests exceeds a predetermined count threshold and determining whether an elapsed time from a last printing exceeds a predetermined time threshold. The plurality of pre-print checks may be generated if the count exceeds the predetermined count threshold or if the elapsed time exceeds the predetermined time threshold. The check print manager 204 is further configured to provide the plurality of pre-print checks to the printer 104. The printer 104 prints the plurality of printed checks in response to being provided the plurality of pre-print checks. The scanner 106 then scans the plurality of printed checks to generate a plurality of check images. Scanning the plurality of printed checks includes scanning a front side and a back side of each printed check.

The check record manager 206 is configured to receive the plurality of check images from the scanner 106 in response to providing the plurality of pre-print checks to the printer 104. The check images are indicative of the plurality of printed checks printed by the printer device. Each check image is indicative of a front side or a back side of a printed check. The check record manager 206 is further configured to update a check record for each printed check of the plurality of printed checks. Each check record is indicative of a unique check identifier, a front side image of the associated printed check, a back side image of the associated printed check, and a hash value of the front side image combined with the back side image. The check record may be stored in a check record table 210 or other database. In some embodiments, updating the check record for each printed check of the plurality of printed checks may include reading a table of check records from the scanner 106.

In some embodiments, updating the check record for each printed check of the plurality of printed checks may include, for each printed check of the plurality of printed checks, converting the front side image and the back side image of the printed check to a base-64 encoded front side image and a base-64 encoded back side image, respectively, determining a unique check identifier based on a graphical code represented in the front side image or the back side image, finding a check record for the printed check that matches the first unique check identifier, calculating the hash value of the base-64 encoded front side image combined with the base-64 encoded back side image, and updating the check record with the hash value, a location of the front side image, and a location of the back side image. In some embodiments, updating the check record for each printed check of the plurality of printed checks further may include sending an update indicative of the hash value and the unique check identifier. In some embodiments, updating the check record for each printed check of the plurality of printed checks further includes moving the plurality of check images to a data storage location, such as a check images data store 212.

The check image interface 208 is configured to receive a check image request, for example from a lock box device 116. The check image request is indicative of a requested hash value. The check image interface 208 is further configured to return a response record in response the check image request. The response record includes the front side image and the back side image that are associated with the requested hash value. In some embodiments, receiving the check image request may include validating security of the check image request. In some embodiments, returning the response record may include determining whether a check record includes a hash value that matches the requested hash value of the check image request, and returning an error if no check record includes the hash value that matches the requested hash value. Returning the response record may further include retrieving a front side image and a back side image from a data storage location indicated by the check record and assigning the front side image and the back side image to the response record.

In some embodiments, the check image interface 208 may be further configured to receive a check re-print request. The check re-print request is indicative of a requested hash value. The check image interface 208 may be further configured to retrieve the front side image and the back side image that are associated with the requested hash value, and the check print manager 204 may be further configured to prepare a pre-print check as a function of the front side image and the back side image and to provide that pre-print check to a printing device. For the check re-print request, the printing device may be a device different from the high volume printer 104, such as a low-volume printer or other printing device capable of printing individual check hard copies.

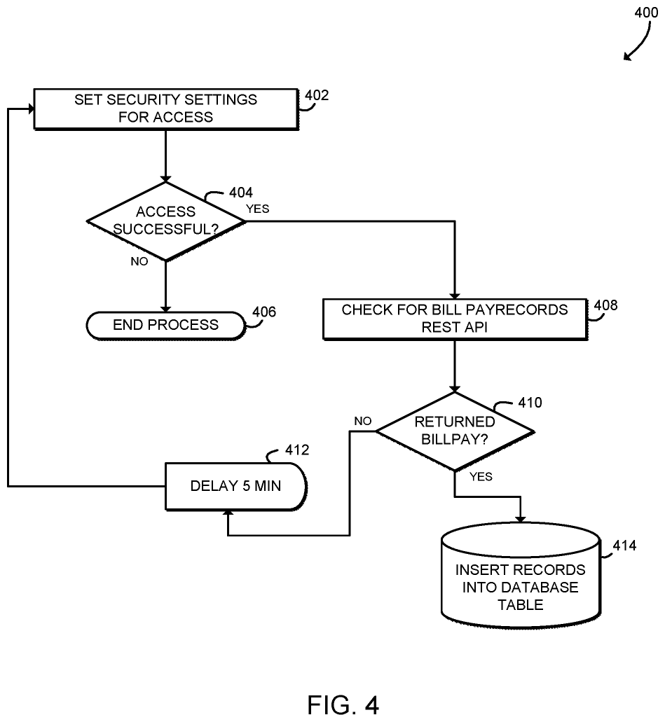

Referring now to FIG. 3, in use, the check print server 102 may execute a method 300 for electronic bill pay with check processing. It should be appreciated that, in some embodiments, the operations of the method 300 may be performed by one or more components of the environment 200 of the check print server 102 as shown in FIG. 2. The method 300 begins with block 302, in which the check print server 102 receives multiple bill pay requests. The check print server 102 may, for example, receive the bill pay requests from one or more bill pay devices 114. Each bill pay device 114 may be operated by a payor, a financial institution, or other initiator of a bill pay transaction. One potential embodiment of a method for receiving bill pay requests is illustrated in FIG. 4 and described further below.

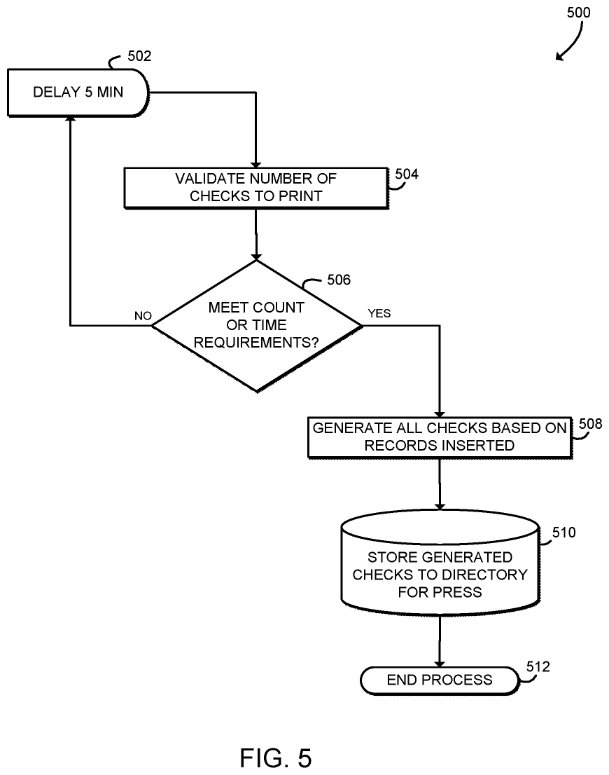

In block 304, the check print server 102 generates multiple checks for printing by the printer 104. The check print server 102 may generate the checks as a digital file in a pre-print format. For example, check print server 102 may generate a PDF file including a 3-up, 5-down imposition layout of checks for printing. The check print server 102 may provide a batch of checks to the printer 104 after a predetermined count of checks are received or after a predetermined time limit. One potential embodiment of a method for generating checks is illustrated in FIG. 5 and described further below.

In block 306, the printer 104 prints the checks and the scanner 106 scans both front and back of the checks. As described above, the checks are printed and scanned continuously before the printed checks are rolled into a roll 112 for storage.

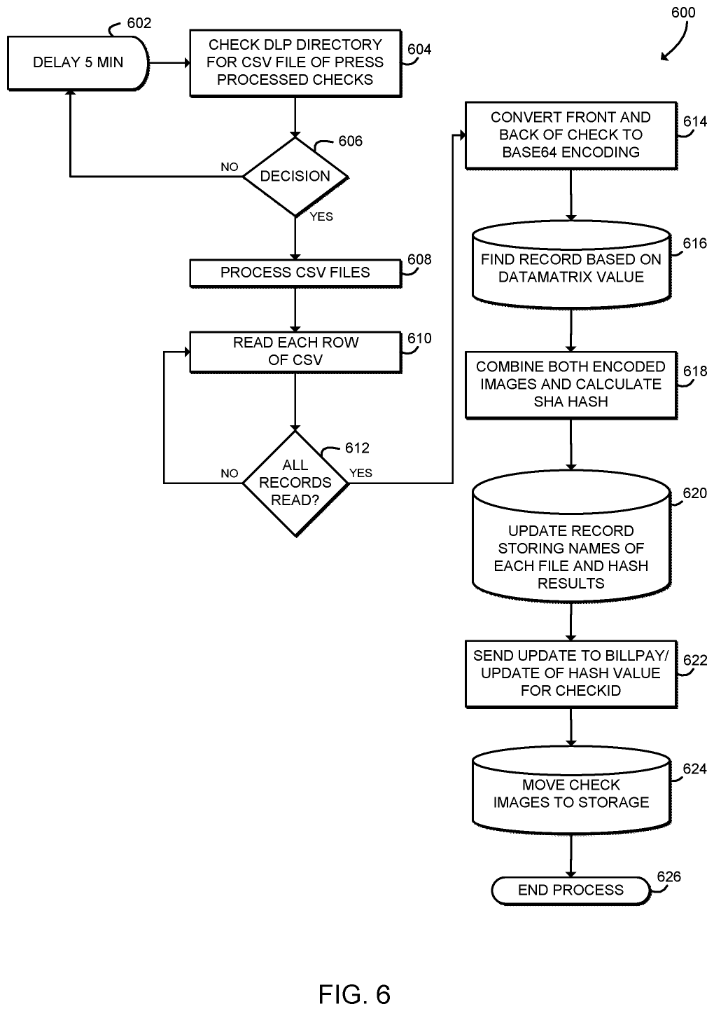

In block 308, the check print server 102 updates a record for each printed check with a hash of the associated check images and the check image location. For example, the check print server 102 may update one or more records in the check record table 210 with updated hash values for each printed check. Similarly, the check print server 102 may update the check print table 310 with one or more filenames, addresses, or other locations of the check images within the check image data store 212. One potential embodiment of a method for updating the check record is illustrated in FIG. 6 and described further below.

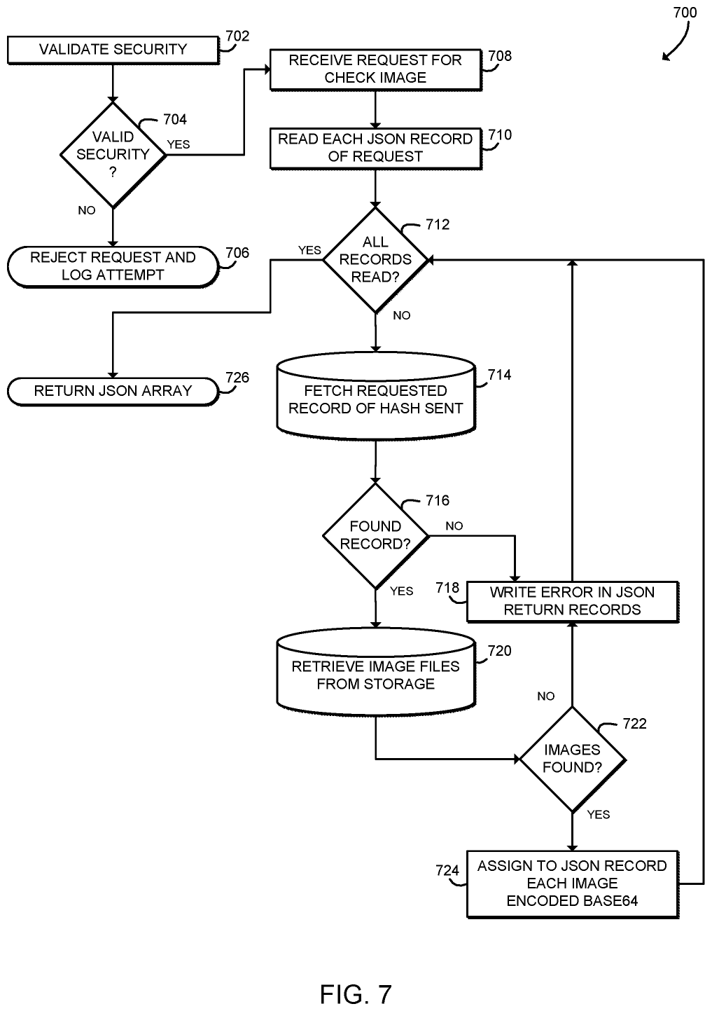

In block 310, the check print server 102 retrieves one or more requested check images by hash value. The check print server 102 may receive one or more requests for a check image from, for example, one or more lock box devices 116. Each request may include a requested hash value. The check print server 102 matches the requested hash value against stored check records, retrieves the associated check images, and replies with the requested check images. One potential embodiment of a method for processing check image requests is illustrated in FIG. 7 and described further below. After responding to the requests for check images, the method 300 loops back to block 302, in which the check print server 102 may continue to process bill pay requests.

Referring now to FIG. 4, in use, the check print server 102 may execute a method 400 for receiving bill pay requests. It should be appreciated that, in some embodiments, the operations of the method 400 may be performed by one or more components of the environment 200 of the check print server 102 as shown in FIG. 2. The method 400 begins with block 402, in which the check print server 102 sets one or more security settings for access to a bill pay REST resource or other bill pay interface established by the check print server 102. Security settings may include access control settings, authentication settings, encryption settings, or other settings that protect the security and/or integrity of the bill pay interface. In block 404, the check print server 102 determines whether an access to the interface with the security settings is successful. If not, the method 400 advances to block 406, in which the method 400 ends. Referring again to block 404, if the access is successful, the method 400 advances to block 408.

In block 408, the check print server 102 checks whether one or more bill pay requests have been received at a bill pay records REST API established by the check print server 102. In block 410, the check print server 102 determines whether any bill pay request records were received. If so, the method 400 branches to block 414, described below. If no bill pay request records were received, the method 400 branches to block 412, in which the check print server 102 delays for five minutes or another predetermined time period. After the delay, the method 400 loops back to block 402 to continue setting security settings and checking the bill pay records REST API. Although the method 400 is illustrated as polling a REST API for bill pay requests, it should be understood that in other embodiments the check print server 102 may use any appropriate technique for receiving bill pay requests, such as event handling, message processing, or other techniques.

Referring again to block 410, if one or more bill pay records are received, the method 400 branches to block 414, in which the check print server 102 inserts the bill pay records into a database table. The bill pay records may include checking information or other payment information, such as date, name, routing number, account number, amount, payee, check number, and reference ID or other unique check identifier. After inserting the bill pay records, the method 400 is completed. The check print server 102 may generate checks for printing based on those bill pay records as described further below. The method 400 may be executed again to process additional bill pay requests.

Referring now to FIG. 5, in use, the check print server 102 may execute a method 500 for generating checks for printing. It should be appreciated that, in some embodiments, the operations of the method 500 may be performed by one or more components of the environment 200 of the check print server 102 as shown in FIG. 2. The method 500 begins with block 502, in which the check print server 102 delays five minutes or another predetermined time period. After the delay, the method 500 proceeds to block 504.

In block 504, the check print server 102 validates a number of checks to print. The check print server 102 may, for example, determine a number of bill pay records that have been inserted into a database since a previous batch of checks were printed. In block 506, the check print server 102 determines whether count requirements or time requirements have been met. The check print server 102 may determine, for example, whether the validated number of checks to print exceeds a predetermined threshold, or whether an amount of time that has elapsed since the previous batch of checks were printed exceeds a predetermined threshold. If the count or time requirements are not met, the method 500 loops back to block 502 to continue waiting for additional checks to print. If the count or time requirements are met, the method 500 advances to block 508.

In block 508, the check print server 102 generates checks to be printed based on the bill pay records inserted into the database. For example, the check print server 102 may generate one or more PDF files that include the checks to be printed. The checks may be arranged in an imposition format such as 3-up, 5-down or in any other pre-print arrangement. Each check to be printed includes checking information from the bill pay record database, such as date, name, routing number, account number, amount, payee, check number, and reference ID or other unique check identifier. In some embodiments, and as described further below, the reference ID may be encoded in a datamatrix, a bar code, or other graphical code represented in the check. In block 510, the check print server 102 stores the generated checks to a directory for press. The check print server 102 may store the generated checks to a directory, file share, server, or other storage location that is accessible to the printer 104 (i.e., the printing press). In block 512, the method 500 is completed. As described above, the printer 104 next prints the generated checks, and the scanner 106 scans the checks off the press and generates check images. The method 500 may be executed again to generate additional check images.

Referring now to FIG. 6, in use, the check print server 102 may execute a method 600 for processing scanned check images. The method 600 may be executed after or contemporaneously with generating checks for printing as described above in connection with the method of FIG. 5. It should be appreciated that, in some embodiments, the operations of the method 600 may be performed by one or more components of the environment 200 of the check print server 102 as shown in FIG. 2. The method 600 begins with block 602, in which the check print server 102 delays five minutes or another predetermined time period. After the delay, the method 600 proceeds to block 604.

In block 604, the check print server 102 checks a DLP directory for a CSV file of press processed checks. The DLP directory may be a directory or other storage location that is audited for data loss protection (DLP) or is otherwise secure. The CSV file is a comma-delimited text file of data generated by the scanner 106 and includes data relating to checks that have been printed and scanned off the press by the scanner 106. The scanner 106 may deposit the CSV file in the DLP directory after or during scanning of a batch of checks. Although illustrated as checking for a CSV file, in other embodiments the scanner 106 may generate information in a different database format, file format, or other data format. In block 606, the check print server 106 determines whether a CSV file was found. If not, the method 600 loops back to block 602 to continue waiting for the scanner 106 to generate a CSV file. If a CSV file exists, the method 600 advances to block 608.

In block 608 the check print server 102 processes CSV files stored in the DLP directory. In block 610, the check print server 102 reads each row of the CSV file. In block 612, the check print server 102 determines whether all records have been read from the CSV file. If not, the method 600 loops back to block 610 to continue reading rows from the CSV file. If all records have been read, the method 600 advances to block 614.

In block 614, the check print server 102 converts images of the front and back of each check to a base64 encoding. The check print server 102 may generate a base-64 encoded image for each of the front and back side of the check. In block 616, the check print server 102 finds a check record based on a datamatrix value represented in a check image. The datamatrix is a two-dimensional bar code printed on the front or back side of the printed check. The datamatrix encodes a reference ID or other unique check identifier. The records for each check from the CSV file are indexed by or otherwise include the reference ID or check identifier encoded in the datamatrix. Thus, the check print server 102 may look up check records by unique check identifier represented in the datamatrix included in a front image or back image of that printed check.

In block 618, the check print server 102 combines both encoded images and calculates a SHA hash of the combined images. The check print server 102 may, for example, concatenate the base64-encoded front side image with the base64-encoded back side image, and then generate a hash value based on the concatenated, encoded images. In block 620 the check print server 102 updates the check record, storing the names of each file and the hash results. The filenames may correspond to each of the front side image and the back side image. The filenames may reference the original images or the base-64 encoded images.

In block 622, the check print server 102 sends an update to bill pay and/or an update of the hash value for each check ID. The check print server 102 generates an update that indicates the generated hash value associated with the reference ID or other unique check identifier for each processed printed check. The check print server 102 may, for example, send updates to a bill pay interface of the check print server 102 or otherwise update the bill pay devices 114 and/or the lock box devices 116. In block 624, the check print server 102 moves the check images to a storage location. After being moved to the storage location, the images may be accessible by the file names stored in the corresponding check record. In block 626, the method 600 is completed. The method 600 may be executed again to process additional check images.

Referring now to FIG. 7, in use, the check print server 102 may execute a method 700 for processing check image requests. It should be appreciated that, in some embodiments, the operations of the method 700 may be performed by one or more components of the environment 200 of the check print server 102 as shown in FIG. 2. The method 700 begins with block 702, in which the check print server 102 validates security of a request for a check image. The check print server 102 may, for example, validate authentication, authorization, encryption, or other security settings of a lock box device 116 or other requesting device. In block 704, the check print server 102 determines whether the security check was valid. If so, the method 700 branches to block 708, as described below. If the security check was not valid, the method 700 branches to block 706, in which the check print server 102 rejects the request and logs the attempt or otherwise performs a security response. After rejecting the request, the method 700 is completed.

Referring back to block 704, if the security check was valid, the method 700 proceeds to block 708, in which the check print server 102 receives a request for a check image. The request may be received from a remote device such as a lock box device 116. Each request is indicative of the hash value associated with a printed check, which is determined as described above in connection with FIG. 6. The request may be embodied as, for example, a JSON array or other JSON data structure.

In block 710, the check print server 102 reads each JSON record of the request. In block 712, the check print server 102 determines whether each JSON record has been read and processed. If so, the method 700 branches to block 726, described below. If JSON records remain, the method 700 advances to block 714.

In block 714, the check print server 102 fetches the check record requested by the hash value sent in the request. The check print server 102 may, for example, query for check records that include a matching hash value. In block 716, the check print server 102 determines whether a check record was found. If so, the method 700 advances to block 720, described below. If no check record was found, the method 700 branches to block 718. In block 718, the check print server 102 writes an error in a JSON return record. After writing the error, the method 700 loops back to block 712 to continue processing JSON request records.

Referring again to block 716, if a check record is found, the method 700 advances to block 720, in which the check print server 102 retrieves the requested check images from storage. The check print server 102 may, for example, retrieve check images using one or more file names included in the check record. In block 722, the check print server 102 determines whether check images were found. If not, the method branches to block 718 to write an error in the JSON return record as described above. If check images were found, the method 700 advances to block 724.

In block 724, the check print server 102 assigns to a JSON record each image encoded in base64. The check print server 102 may, for example, write each base-64 encoded image into one or more JSON return records. After assigning the images, the method 700 loops back to block 712 to continue processing JSON request records.

Referring back to block 712, if the check print server 102 determines that all JSON request records have been read or otherwise processed, the method 700 branches to block 726. In block 726, the check print server 102 returns a JSON array to the requestor, for example to lock box device 116. The JSON array may include one or more check images, errors, or other return information generated by the check print server 102. After returning the response, the method 700 is completed. The method 700 may be executed again to service additional check image requests.

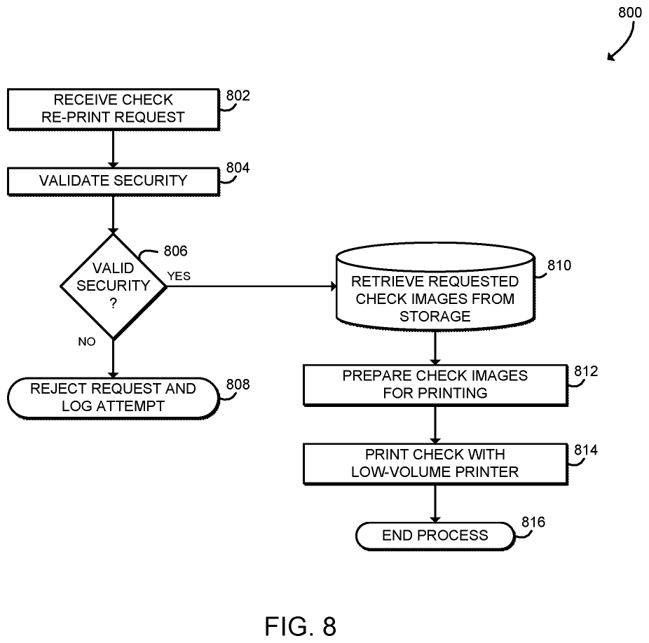

Referring now to FIG. 8, in use, the check print server 102 may execute a method 800 for processing check re-print requests. It should be appreciated that, in some embodiments, the operations of the method 800 may be performed by one or more components of the environment 200 of the check print server 102 as shown in FIG. 2. The method 800 begins with block 802, in which the check print server 102 may receive a request for re-printing a hard copy of an individual check. This individual check may be stored on a roll 112 of printed checks or may have previously been destroyed. The request may be received, for example, from the bill pay device 114, the lock box device 116, or another device.

In block 804, the check print server 102 may validate security of the request for the re-printing the check. The check print server 102 may, for example, validate authentication, authorization, encryption, or other security settings of a bill pay device 114, a lock box device 116, or other requesting device. In block 806, the check print server 102 determines whether the security check was valid. If so, the method 800 branches to block 810, as described below. If the security check was not valid, the method 800 branches to block 808, in which the check print server 102 rejects the request and logs the attempt or otherwise performs a security response. After rejecting the request, the method 800 is completed.

Referring back to block 806, if the security check was valid, the method 800 proceeds to block 810, in which the check print server 102 retrieves the check images associated with the requested check from storage (e.g., the front side image and the back side image). The request identifies the printed check to be re-printed, for example by indicating the hash value associated with the printed check, a reference ID, or other unique check identifier. The check print server 102 uses this check identifier to retrieve the check images.

In block 812, the check print server 102 prepares the check images for printing. The check print server 102 may, for example, prepare a PDF file or other printable file that includes the requested check image on a single page. In block 814, the check print server 102 instructs a printer to print the requested check image as a hard copy. The hard copy may be printed with a low-volume printer capable of printing checks for payment, for example a printer that supports printing with microline ink and/or microline toner or otherwise supports various physical features of hard copy checks. After printing the hard copy of the requested check, the method 800 is completed. Thus, the check print server 102 may support reprinting hard copies of checks that may be cashed or otherwise presented to a bank or other financial institution for payment. Those reprinted checks may represent a relatively small proportion of the checks that were originally printed on the roll 112.

1. A computing device for check processing, the computing device comprising:
a bill pay interface to receive a plurality of bill pay requests, wherein each bill pay request is indicative of a payee, an amount, and a unique check identifier;
a check print manager to (i) generate a plurality of pre-print checks as a function of the plurality of bill pay requests and (ii) provide the plurality of pre-print checks to a printer device;
a check record manager to (i) receive a plurality of check images from a scanner device in response to provision of the plurality of pre-print checks to the printer device, wherein the check images are indicative of a plurality of printed checks printed by the printer device, and wherein each check image is indicative of at least one of a front side or a back side of a printed check; and (ii) update a check record for each printed check of the plurality of printed checks, wherein each check record is indicative of a) a unique check identifier; b) at least one of a front side image of the associated printed check or a back side image of the associated printed check; and c) a hash value; and
a check image interface to (i) receive a check image request, wherein the check image request is indicative of a requested hash value, and (ii) return a response record in response to receipt of the check image request, wherein the response record includes at least one of the front side image or the back side image that are associated with the requested hash value.

2. The computing device of claim 1, wherein:
the printer device is further configured to print the plurality of printed checks in response to the provision of the plurality of pre-print checks to the printer device; and
the scanner device is configured to scan the plurality of printed checks to generate the plurality of check images, wherein scanning the plurality of printed checks comprises scanning a front side and a back side of each printed check.

3. The computing device of claim 1, wherein:
the bill pay interface further includes a security setting for access and
is configured to receive the plurality of bill pay requests in response to entry of the security setting.

4. The computing device of claim 1, wherein generating the plurality of pre-print checks includes the steps of:
determining whether a count of the plurality of bill pay requests exceeds a predetermined count threshold;
determining whether an elapsed time from a last printing exceeds a predetermined time threshold; and
generating the plurality of pre-print checks in response to a determination that the count exceeds the predetermined count threshold or a determination that the elapsed time exceeds the predetermined time threshold.

5. The computing device of claim 1, wherein updating the check record for each printed check of the plurality of printed checks comprises reading a table of check records from the scanner device, wherein each check record is indicative of a unique check identifier.

6. The computing device of claim 1, wherein updating the check record for each printed check of the plurality of printed checks includes:
converting at least one of the front side image or the back side image of the printed check to a base-64 encoded front side image and a base-64 encoded back side image;
determining a first unique check identifier based on a graphical code represented in the front side image or the back side image;
finding a first check record for the printed check that matches the first unique check identifier;
calculating a first hash value of the base-64 encoded front side image combined with the base-64 encoded back side image; and
updating the first check record with the first hash value, a location of the front side image, and a location of the back side image.

7. The computing device of claim 6, wherein updating the check record for each printed check of the plurality of printed checks further comprises moving the plurality of check images to a data storage location.

8. The computing device of claim 1, wherein receiving the check image request comprises validating security of the check image request.

9. The computing device of claim 1, wherein returning the response record comprises:
determining whether a check record includes a hash value that matches the requested hash value of the check image request; and
returning an error in response to a determination that no check record includes the hash value that matches the requested hash value;
wherein returning the response record further comprises returning the response record in response to a determination that the check record includes the hash value that matches the requested hash.

10. The computing device of claim 9, wherein returning the response record further includes:
retrieving at least a front side image or a back side image from a data storage location indicated by the check record in response to the determination that the check record includes the hash value that matches the requested hash; and
assigning the front side image and the back side image to the response record in response to retrieval of the front side image and the back side image.

11. The computing device of claim 1, wherein:
the check image interface further (i) receives a check re-print request, wherein the check re-print request is indicative of the requested hash value, and (ii) retrieves at least the front side image or the back side image that is associated with the requested hash value; and
the check print manager is further configured to prepare a second pre-print check as a function of at least the front side image or the back side image.

12. The computing device of claim 11, wherein the check print manager further provides the second pre-print check to a second printing device, wherein the second printer device comprises a low-volume printer.

13. One or more computer-readable storage media comprising a plurality of instructions that in response to being executed cause a check print server to:
receive a plurality of bill pay requests, wherein each bill pay request is indicative of a payee, an amount, and a unique check identifier;
generate a plurality of pre-print checks as a function of the plurality of bill pay requests;
provide the plurality of pre-print checks to a printer device;
receive a plurality of check images from a scanner device in response to providing the plurality of pre-print checks to the printer device, wherein the check images are indicative of a plurality of printed checks printed by the printer device, wherein each check image is indicative of at least one of a front side or a back side of a printed check;
update a check record for each printed check of the plurality of printed checks, wherein each check record is indicative of a unique check identifier, at least one of a front side image of the associated printed check or a back side image of the associated printed check, and a hash value;
receive a check image request, wherein the check image request is indicative of a requested hash value; and
return a response record in response to receiving the check image request, wherein the response record includes at least one of the front side image or the back side image that are associated with the requested hash value.

14. The one or more computer-readable storage media of claim 13, wherein generating the plurality of pre-print checks includes:
determining whether a count of the plurality of bill pay requests exceeds a predetermined count threshold;
determining whether an elapsed time from a last printing exceeds a predetermined time threshold; and
generating the plurality of pre-print checks in response to determining that the count exceeds the predetermined count threshold or determining that the elapsed time exceeds the predetermined time threshold.

15. The one or more computer-readable storage media of claim 13, wherein to update the check record for each printed check of the plurality of printed checks includes:
converting at least the front side image or the back side image of the printed check to a base-64 encoded front side image and a base-64 encoded back side image;
determining a first unique check identifier based on a graphical code represented in the front side image or the back side image;
finding a first check record for the printed check that matches the first unique check identifier;
calculating a first hash value of the base-64 encoded front side image combined with the base-64 encoded back side image; and
updating the first check record with the first hash value, a location of the front side image, and a location of the back side image.

16. The one or more computer-readable storage media of claim 13, wherein to receive the check image request comprises validating security of the check image request.

17. A method for check processing, the method comprising:
receiving, by a check print server, a plurality of bill pay requests, wherein each bill pay request is indicative of a payee, an amount, and a unique check identifier;
generating, by the check print server, a plurality of pre-print checks as a function of the plurality of bill pay requests;
providing, by the check print server, the plurality of pre-print checks to a printer device;
receiving, by the check print server, a plurality of check images from a scanner device in response to providing the plurality of pre-print checks to the printer device, wherein the check images are indicative of a plurality of printed checks printed by the printer device, wherein each check image is indicative of at least one of a front side or a back side of a printed check;
updating, by the check print server, a check record for each printed check of the plurality of printed checks, wherein each check record is indicative of a unique check identifier, at least one of a front side image of the associated printed check or a back side image of the associated printed check, and a hash value;
receiving, by the check print server; a check image request, wherein the check image request is indicative of a requested hash value; and
returning, by the check print server, a response record in response to receiving the check image request, wherein the response record includes at least one of the front side image or the back side image that are associated with the requested hash value.

18. The method of claim 17, wherein generating the plurality of pre-print checks comprises:
determining whether a count of the plurality of bill pay requests exceeds a predetermined count threshold;
determining whether an elapsed time from a last printing exceeds a predetermined time threshold; and
generating the plurality of pre-print checks in response to determining that the count exceeds the predetermined count threshold or determining that the elapsed time exceeds the predetermined time threshold.

19. The method of claim 17, wherein updating the check record for each printed check of the plurality of printed checks comprises, for each printed check of the plurality of printed checks:
converting at least one of the front side image or the back side image of the printed check to a base-64 encoded front side image and a base-64 encoded back side image;
determining a first unique check identifier based on a graphical code represented in the front side image or the back side image;
finding a first check record for the printed check that matches the first unique check identifier;
calculating a first hash value of the base-64 encoded front side image combined with the base-64 encoded back side image; and
updating the first check record with the first hash value, a location of the front side image, and a location of the back side image.

20. The method of claim 17, wherein receiving the check image request comprises validating security of the check image request.
